(19) United States
(12) Patent Application Publication
(10) Pub. No.: US 2023/0311379 A1
(43) Pub. Date: Oct. 5, 2023

(54) INJECTION APPARATUS, MANUFACTURING SYSTEM, AND MANUFACTURING METHOD FOR PRODUCT

(71) Applicant: CANON KABUSHIKI KAISHA, Tokyo (JP)

(72) Inventors: KOTA YAGI, Tokyo (JP); HIROKI AKATSUKA, Ibaraki (JP)

(21) Appl. No.: 18/328,923

(22) Filed: Jun. 5, 2023

Related U.S. Application Data
(63) Continuation of application No. PCT/JP2021/046537, filed on Dec. 16, 2021.

(30) Foreign Application Priority Data
Dec. 18, 2020 (JP) 2020-209968

(51) Int. Cl. B29C 45/07; B29C 45/20; B29C 45/58

(52) U.S. Cl. CPC B29C 45/07; B29C 45/20; B29C 45/586; B29C 2045/202

(57) ABSTRACT

An injection apparatus includes a plasticizing portion configured to plasticize a molding material, a nozzle configured to eject the molding material, and a changing mechanism capable of changing an orientation of the plasticizing portion and the nozzle.

### CROSS-REFERENCE TO RELATED APPLICATIONS

This application is a Continuation of International Patent Application No. PCT/JP2021/046537, filed Dec. 16, 2021, which claims the benefit of Japanese Patent Application No. 2020-209968, filed Dec. 18, 2020, both of which are hereby incorporated by reference herein in their entirety.

### BACKGROUND OF THE INVENTION

### Field of the Invention

The present invention relates to a technique of injection molding.

### Description of the Related Art

Generally, an injection molding machine that injects a molding material into a mold and manufactures a molded product is known. Examples of the injection molding machine include a lateral-type injection molding machine including a mold clamping mechanism that opens and closes a mold in the horizontal direction. Japanese Patent Laid-Open No. 2016-155266 discloses a manufacturing system that performs integral molding from a plurality of molding materials of different materials or different colors by combining an injection apparatus with a general-purpose injection molding machine. In addition, a manufacturing system that performs family molding in which a plurality of molded products are molded in a single mold is also known.

### SUMMARY OF THE INVENTION

According to a first aspect of the present disclosure, an injection apparatus includes a plasticizing portion configured to plasticize a molding material, a nozzle configured to eject the molding material, and a changing mechanism capable of changing an orientation of the plasticizing portion and the nozzle.

According to a second aspect of the present disclosure, an injection apparatus configured to inject a first molding material into a first cavity defined in a mold, and includes an apparatus body including a plasticizing portion configured to plasticize the first molding material, a nozzle configured to eject the first molding material, and a casing in which the plasticizing portion and the nozzle are disposed, and a first mechanism capable of attaching the casing to the mold in an orientation in which an ejection direction of the first molding material from the nozzle is an upward direction.

According to a third aspect of the present disclosure, an injection apparatus configured to inject a first molding material into a first cavity defined in a mold, and includes an apparatus body including a nozzle configured to eject the first molding material, and a first mechanism capable of attaching the apparatus body to the mold in an orientation in which an ejection direction of the first molding material from the nozzle is an upward direction. The first mechanism is capable of attaching the apparatus body to a movable mold among a fixed mold and the movable mold that are included in the mold, and a spacer for maintaining an interval between the movable mold and the apparatus body is further provided.

Further features of the present invention will become apparent from the following description of exemplary embodiments with reference to the attached drawings.

### BRIEF DESCRIPTION OF THE DRAWINGS

FIG. 1 is a side view of a manufacturing system according to a first embodiment.

FIG. 2 is a section view of the manufacturing system according to the first embodiment.

FIG. 3 is an explanatory diagram of an injection portion according to the first embodiment.

FIG. 4 is a section view of a plasticizing portion of an injection apparatus according to the first embodiment.

FIG. 5 is a perspective view of an injection apparatus according to a second embodiment.

FIG. 6 is a section view of the injection apparatus according to the second embodiment.

FIG. 7A is an explanatory diagram of an operation of lifting up an apparatus body according to the second embodiment.

FIG. 7B is an explanatory diagram of the operation of lifting up the apparatus body according to the second embodiment.

FIG. 8 is a perspective view of an injection apparatus according to a third embodiment.

FIG. 9A is a perspective view of the injection apparatus according to the third embodiment.

FIG. 9B is a section view of the injection apparatus according to the third embodiment.

FIG. 10 is an explanatory diagram of an operation of the injection apparatus in a manufacturing system according to the third embodiment.

FIG. 11 is a side view of a manufacturing system according to a fourth embodiment.

FIG. 12A is a plan view of an attaching mechanism according to the fourth embodiment.

FIG. 12B is a plan view of the attaching mechanism according to the fourth embodiment.

FIG. 13 is a side view of a manufacturing system according to a fifth embodiment.

### DESCRIPTION OF THE EMBODIMENTS

Embodiments for implementing the present invention will be described in detail below with reference to drawings.

### First Embodiment

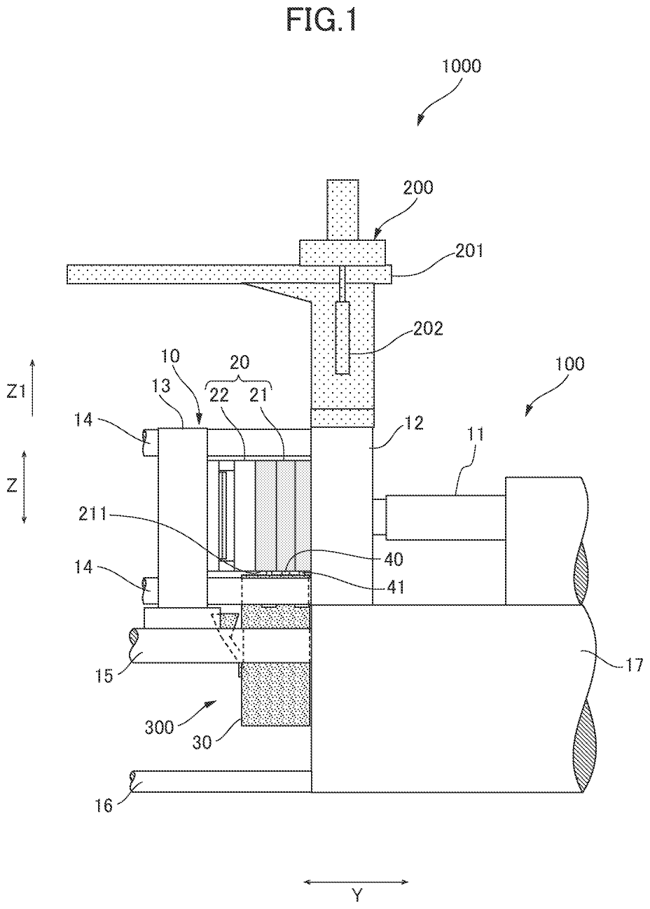

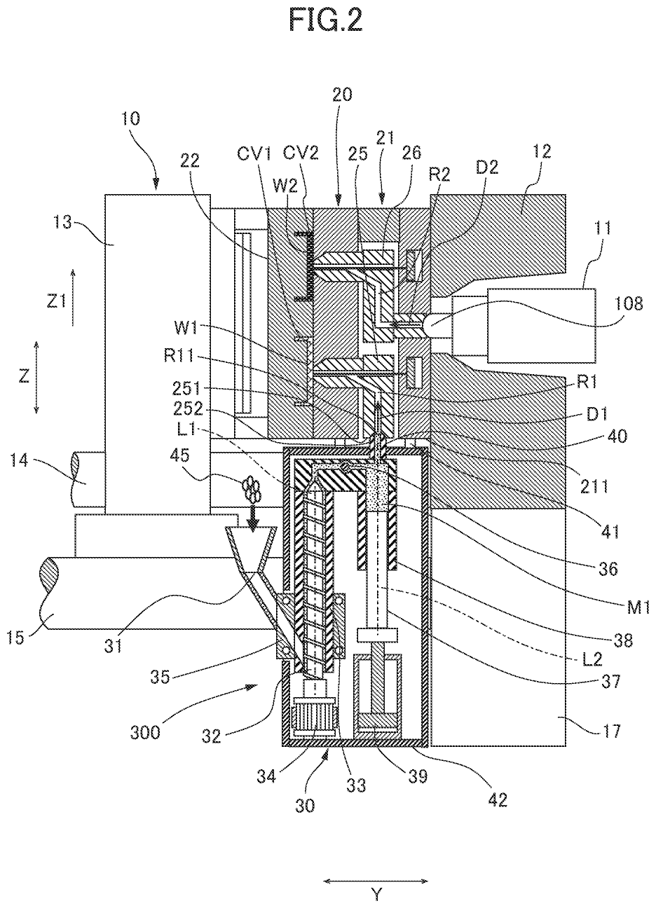

FIG. 1 is a manufacturing system 1000 according to a first embodiment. FIG. 2 is a section view of the manufacturing system 1000 illustrated in FIG. 1. The manufacturing system 1000 is installed in a factory. In the present embodiment, the manufacturing system 1000 performs family molding in which a plurality of products, for example, two products W1 and W2 are molded in a single mold 20.

The manufacturing system 1000 includes the mold 20, an injection apparatus 300 that injects a first molding material into the mold 20, an injection molding machine 100, and a robot arm 200 serving as an example of a take-out machine capable of taking out a product that is a molded product from the mold 20. The injection molding machine 100 is a lateral injection molding machine. The mold 20 is attached to the injection molding machine 100. The injection apparatus 300 is detachably attached to a lower portion of the mold 20.

A general-purpose injection molding machine can be used as the injection molding machine 100. The injection molding machine 100 includes an injection portion 11 that injects a second molding material, a mold clamping portion 10 capable of opening and closing the mold 20, a frame 15 that supports the mold clamping portion 10, a base 16 to which the frame 15 is fixed, and a support stage 17. The injection portion 11 is supported by the support stage 17. The frame 15 is formed to extend in a Y direction that is a horizontal direction from the support stage 17, and supports the mold clamping portion 10 together with the support stage 17. The injection portion 11 is attached to a side portion of the mold 20. The base 16 is disposed under the frame 15, and is formed to extend in the Y direction from the support stage 17. For example, the base 16 is a member having a flat plate shape, and the upper surface of the base 16 is preferably a flat surface.

The mold clamping portion 10 includes a stationary-side platen 12, a movable-side platen 13 movable in the Y direction that is a horizontal direction with respect to the stationary-side platen 12, and a tie bar 14 that guides the movable-side platen 13 in the Y direction and applies a mold clamping force to the mold 20. The movable-side platen 13 is supported by the frame 15 so as to be slidable with respect to the frame 15. The stationary-side platen 12 is fixed to the support stage 17.

The mold 20 includes a stationary mold 21 that is a mold on the stationary side, and a movable mold 22 that is a mold on the movable side. The stationary mold 21 is fixed to the stationary-side platen 12, and the movable mold 22 is fixed to the movable-side platen 13. Therefore, the mold clamping portion 10 is capable of opening and closing the mold 20 in the Y direction that is a horizontal direction. As a result of the mold clamping portion 10 clamping the mold 20, a cavity CV1 serving as a first cavity and a cavity CV2 serving as a second cavity are defined inside the mold 20.

In addition, the stationary mold 21 of the mold 20 includes a block 25 that defines a hot runner R1 connected to the cavity CV1, and a block 26 that defines a hot runner R2 connected to the cavity CV2. The injection apparatus 300 is connected to the hot runner R1 from below. The injection portion 11 of the injection molding machine 100 is connected to the hot runner R2 from a different direction than the injection apparatus 300, that is, from the side.

The robot arm 200 is disposed at a position in which the products W1 and W2 molded in the mold 20 can be taken out from above the mold 20 that has been opened. In the present embodiment, the robot arm 200 is disposed on the stationary-side platen 12. The robot arm 200 includes an arm body 201 and an end effector 202, and is capable of obtaining the products W1 and W2 from the opened mold 20 by the end effector 202. The end effector 202 may be a gripping mechanism capable of gripping a product, or a vacuum fastener capable of attracting a product by vacuum suction.

The first molding material that the injection apparatus 300 injects may be either a metal material or a resin material. The resin material may be either a thermoplastic resin or a heat-curable resin. In the present embodiment, description will be given assuming that the first molding material injected by the injection apparatus 300 is a resin material M1 that is a thermoplastic resin.

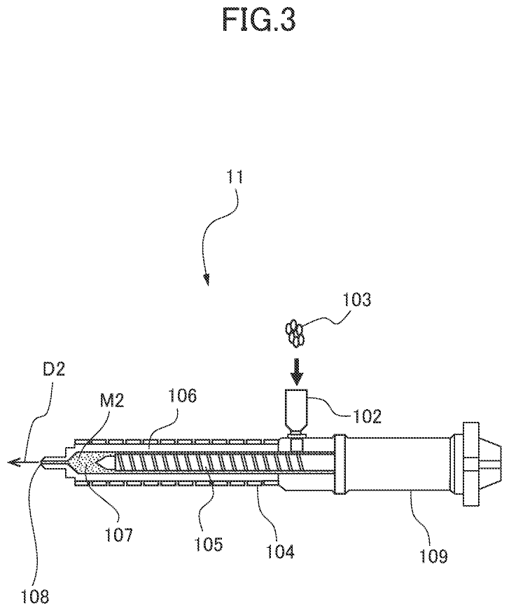

FIG. 3 is an explanatory diagram of the injection portion 11 according to the first embodiment. The second molding material injected by the injection portion 11 may be different or the same in color or material quality as the first molding material injected by the injection apparatus 300. The second molding material injected by the injection portion 11 may be either a metal material or a resin material. The resin material may be either a thermoplastic resin or a heat-curable resin. In the present embodiment, description will be given assuming that the second molding material injected by the injection portion 11 is a resin material M2 that is a thermoplastic resin.

The injection portion 11 plasticizes a supplied resin material 103, and injects the molten resin material M2 into the mold 20. The injection portion 11 is of an in-line screw type. The injection portion 11 includes a hopper 102, a heater 104, a screw 105, a cylinder 106 including a reservoir portion 107, a nozzle 108, and an injection unit 109. When the resin material 103 having a pellet shape is charged into the hopper 102, the resin material 103 is heated by the heater 104 and is thus plasticized, and is pressed by the screw 105 to flow toward the reservoir portion 107 in the cylinder 106. Then, the liquid resin material M2 reserved in the reservoir portion 107 is ejected in an ejection direction D2 from the nozzle 108 by an action of the injection unit 109, and is thus injected into the mold 20 of FIG. 2. The resin material M2 ejected from the nozzle 108 passes through the hot runner R2 communicating with the nozzle 108, and is injected into the cavity CV2.

The injection apparatus 300 illustrated in FIG. 2 plasticizes a supplied resin material 45, and injects the molten resin material M1 into the mold 20. The injection apparatus 300 includes an apparatus body 30, and an attaching mechanism 41 serving as an example of a first mechanism. The apparatus body 30 of the injection apparatus 300 is of a screw pre-plunger type. The apparatus body 30 roughly includes a hopper 31, a screw 32, a barrel 33, a plasticizing driving portion 34, a cooling block 35, a non-return valve 36, a plunger 37, a cylinder 38, an injection driving portion 39, a nozzle 40, and a casing 42. The screw 32, the barrel 33, the plasticizing driving portion 34, the non-return valve 36, the plunger 37, the cylinder 38, and the injection driving portion 39 are disposed inside the casing 42.

The hopper 31 is connected to the barrel 33 via the cooling block 35. A resin material 45 that is a thermoplastic resin is charged into the hopper 31. The hopper 31 supplies the resin material 45 into the barrel 33. The barrel 33 is heated by an unillustrated heating apparatus, and thus the temperature thereof is adjusted to a predetermined temperature at which the supplied resin material 45 is plasticized. The barrel 33 is disposed on the outside of the screw 32. That is, the screw 32 is disposed inside the barrel 33. The screw 32 extends in a direction in which an axis L1 extending in the Z direction that is a direction perpendicular to the base 16. The Z direction is a direction parallel to the vertical direction. That is, the screw 32 is disposed such that the tip of the screw 32 directs in an upward direction Z 1. The axis L1 is a rotation axis of the screw 32. The screw 32 rotates in a radial direction about the axis L1, and thus moves the resin material 45 supplied from the hopper 31 to the tip of the screw 32 while plasticizing the resin material 45. The plasticizing driving portion 34 rotates the screw 32 in the radial direction about the axis L1. The hopper 31 and the barrel 33 are interconnected by the cooling block 35.

The barrel 33 is connected to the cylinder 38 via the non-return valve 36. A predetermined amount of the resin material M1 plasticized by the screw 32 passes through the non-return valve 36 and is conveyed into the cylinder 38. The cylinder 38 is at a temperature adjusted by an unillustrated heating apparatus to a predetermined temperature to maintain the resin material M1 in a plasticized state, and maintains the resin material M1 conveyed into the cylinder 38 at a high temperature. The plunger 37 is disposed inside the cylinder 38. The plunger 37 extends in a direction in which an axis L2 parallel to the axis L1 extends. The plunger 37 is movable in a thrust direction that is a direction in which the axis L2 extends, and is driven in the thrust direction by the injection driving portion 39. The axis L2 is an axis passing through the center of the plunger 37. The nozzle 40 is disposed on the axis L2. The resin material M1 in the cylinder 38 is controlled to a predetermined pressure by the plunger 37. Since the screw 32 and the plunger 37 are disposed such that the axis L1 passing through the center of the screw 32 and the axis L2 passing through the center of the plunger 37 are parallel, the apparatus body 30 is short in the Y direction that is a horizontal direction, and thus it is attempted to make the apparatus body 30 compact.

To be noted, the axes L1 and L2 are virtual lines at an interval in the Y direction. The axis L1 and the axis L2 are preferably parallel, but may be approximately parallel to each other, from the viewpoint of miniaturizing the apparatus body 30. Here, the axis L1 and the axis L2 being approximately parallel to each other means that the angle formed by the axis L1 and the axis L2 is larger than 0° and equal to or smaller than 10°.

In addition, the axes L1 and L2 are preferably parallel, but may be approximately parallel to a normal line perpendicular to the upper surface of the base 16 of FIG. 1, from the viewpoint of miniaturizing the manufacturing system 1000 in a state in which the injection apparatus 300 is attached to the mold 20. Here, the axes L1 and L2 each being approximately parallel to the normal line means that the angle formed by the normal line and each of the axes L1 and L2 is larger than 0° and equal to or smaller than 10°.

After the predetermined amount of the resin material M1 is conveyed to the plunger 37, the plunger 37 moves forward at a predetermined speed, and thus the resin material M1 is ejected from the nozzle 40 in the ejection direction D1. At this time, the resin material M1 in the cylinder 38 flowing back to the barrel 33 is prevented by the non-return valve 36. The resin material M1 ejected from the nozzle 40 passes through the hot runner R1 communicating with the nozzle 40, and is injected into the cavity CV1.

The attaching mechanism 41 is capable of attaching the apparatus body 30 to the mold 20 in an orientation in which the ejection direction D1 of the resin material M1 from the nozzle 40 is the upward direction Z1. In the present embodiment, the attaching mechanism 41 is capable of attaching the apparatus body 30 to the stationary mold 21 among the stationary mold 21 and the movable mold 22 of the mold 20. In the orientation of the apparatus body 30 in which the ejection direction D1 is the upward direction Z1, the hopper 31 is open in the upward direction Z1. In the present embodiment, the attaching mechanism 41 is capable of attaching the apparatus body 30 to a lower portion of the stationary mold 21 of the mold 20, that is, to a lower surface 211. Here, the upward direction Z1 is preferably a normal direction of the upper surface of the base 16, but may be slightly inclined with respect to the normal direction. For example, the upward direction Z1 may be inclined with respect to the normal direction of the upper surface of the base 16 within a range of 10° or less.

As a result of the apparatus body 30 being attached to the lower portion of the stationary mold 21 of the mold 20 by the attaching mechanism 41, the nozzle 40 and the cavity CV1 communicate with each other via the hot runner R1 defined by the block 25. A lower surface 251 of the block 25 has a portion 252 that defines an inlet port R11 of the hot runner R1 and comes into contact with the nozzle 40. The portion 252 is a recess portion recessed in the upward direction Z1 such that the tip of the nozzle 40 engages therewith. In addition, the nozzle 108 and the cavity CV2 communicate with each via the hot runner R2 defined by the block 26, as a result of the injection portion 11 being attached to a side portion of the stationary mold 21.

A manufacturing method for the products W1 and W2 using the manufacturing system 1000 will be described. First, a process before a manufacturing process will be described. The mold 20 is set to the injection molding machine 100. Next, the injection apparatus 300 is conveyed to a position under the mold 20, and the apparatus body 30 is attached to the mold 20 by the attaching mechanism 41. As a result of this, preparation of the manufacturing system 1000 used for manufacturing the products W1 and W2 is completed.

Next, the manufacturing process will be described. By clamping the stationary mold 21 and the movable mold 22 of the mold 20, the cavities CV1 and CV2 are defined in the mold 20.

By discharging the resin material M1 serving as a first molding material by the injection apparatus 300, the resin material M1 is injected into the cavity CV1 through the hot runner R1. Similarly, by discharging the resin material M2 serving as a second molding material by the injection portion 11, the resin material M2 is injected into the cavity CV2 through the hot runner R2. As a result of the resin materials M1 and M2 being cooled by the mold 20, the resin materials M1 and M2 injected into the cavities CV1 and CV2 are solidified, and thus the products W1 and W2 are molded inside the mold 20. As a result of this, the two products W1 and W2 can be molded in the single mold 20.

Then, the stationary mold 21 and the movable mold 22 of the mold 20 are opened. At this time, the products W1 and W2 are held by one of the stationary mold 21 or the movable mold 22, for example, the movable mold 22. In addition, as a result of using the hot runners R1 and R2, the products W1 and W2 not having runners are held by the movable mold 22. Therefore, a process of removing the runners from the products W1 and W2 is not necessary, and thus the productivity is improved.

In addition, by using the hot runners R1 and R2, a flow path for the resin material M2 supplied to the mold 20 from the side and a flow path for the resin material M1 supplied to the mold 20 from below can be realized with a simple configuration of the mold 20. Particularly, the configuration of the stationary mold 21 can be simplified.

In the present embodiment, the robot arm 200 is disposed on the stationary-side platen 12. The products W1 and W2 held by the movable mold 22 of the mold 20 are sequentially taken out by the robot arm 200 from above the opened mold 20. As described above, in the first embodiment, the products W1 and W2 held by the opened mold 20 are taken out by the robot arm 200 without falling off from the mold 20. As a result of this, the products W1 and W2 are reliably taken out by the robot arm 200 without being caught and remaining between the stationary mold 21 and the movable mold 22 of the mold 20. As a result of this, the stationary mold 21 and the movable mold 22 nipping the products when clamping the mold 20 in the next manufacturing process after taking out the products can be prevented.

The manufacturing system including the injection molding machine needs to be installed so as not to interfere with other peripheral devices in the factory. However, in the case of additionally installing an injection apparatus on a side portion of the mold, the additionally-installed injection apparatus greatly sticks out to the side of the mold, and thus the area occupied by the manufacturing system in the factory increases. Further, in some cases, it has been necessary to change the layout in the factory such that the manufacturing system does not interfere with the peripheral devices.

As described above, according to the present embodiment, since the apparatus body 30 is attached to a lower portion of the mold 20 by the attaching mechanism 41, the area occupied by the manufacturing system 1000 in the factory is reduced as compared with a case where the apparatus body 30 is attached to a side portion of the mold 20. Therefore, reducing the space for the manufacturing system 1000 in the factory can be realized.

In addition, since the injection apparatus 300 is disposed under the mold 20, the robot arm 200 can access a space between the stationary mold 21 and the movable mold 22 of the mold 20 from above the opened mold 20 to obtain the products W1 and W2. As a result of this, the products W1 and W2 do not need to fall off from the mold 20 when opening the mold 20, and thus the products W1 and W2 can be reliably taken out from the mold 20 by the robot arm 200.

In addition, since the injection apparatus 300 is disposed under the mold 20, water plumbing and electric wiring provided to the mold 20 can be drawn from the side of the mold 20, and thus the injection apparatus 300 interfering with the water plumbing and electric wiring can be prevented.

In addition, an unillustrated safety door is provided on the side of the mold 20. In the case of attaching the injection apparatus to the mold from the side, since the safety door is provided, the layout needs to be changed, and a protection fence needs to be newly provided. In contrast, in the present embodiment, since the injection apparatus 300 is disposed under the mold 20, the safety door provided on the side of the mold 20 can be used as is, and capital investment can be reduced. In addition, the workload for reconsidering the layout in the factory can be also reduced.

In addition, since the injection apparatus 300 is disposed under the mold 20, it is easier for a worker to access the mold 20 during maintenance than in the case where the mold 20 is disposed on the side of the mold, and thus the workability for the maintenance is improved.

To be noted, although the one cavity CV1 is connected to the one hot runner R1 in the present embodiment, a configuration in which one hot runner R1 is connected to a plurality of first cavities may be employed. In addition, although the one cavity CV2 is connected to the one hot runner R2, a configuration in which the one hot runner R2 is connected to a plurality of second cavities may be employed. That is, the mold 20 may be configured such that N molded products are molded by the injection apparatus 300 and M molded products are molded by the injection portion 11 of the injection molding machine 100. N and M are integers of 1 or more.

A space surrounded by the stationary-side platen 12, the movable-side platen 13, the tie bar 14, the frame 15, the base 16, and the mold 20 is provided below the mold 20. In the manufacturing system 1000, in the state in which the mold 20 is clamped, a position where the gap in the Z direction is the widest in the space below the mold 20 is between the upper surface of the base 16 and the lower surface of the mold 20.

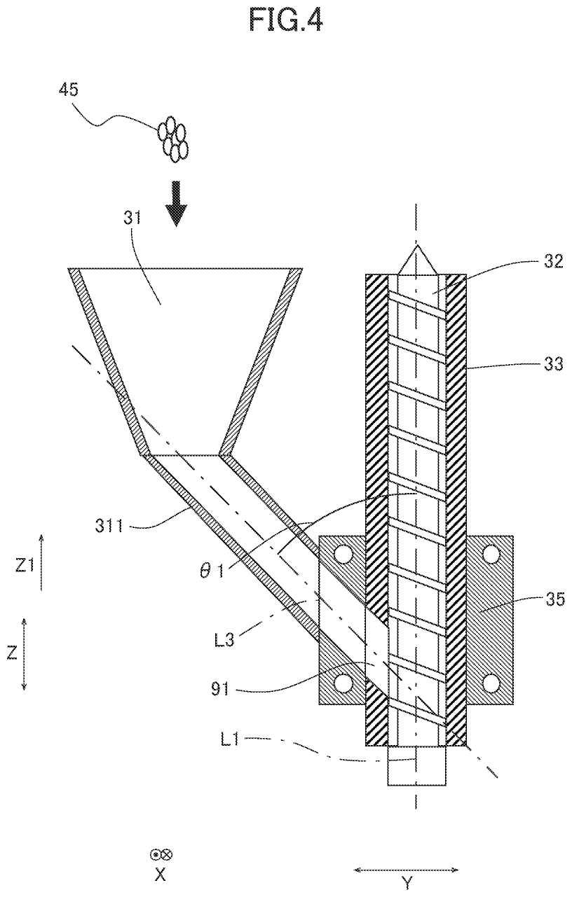

FIG. 4 is a section view of the plasticizing portion of the injection apparatus 300 according to the first embodiment. The longer the screw 32 is, the more stably the charged resin material 45 can be plasticized and kneaded. Therefore, by disposing the tip of the screw 32 so as to direct in the upward direction Z1, that is, disposing the screw 32 such that the axis L1 passing through the center of the screw 32 extends in the Z direction perpendicular to the upper surface of the base 16, the length of the screw 32 can be increased. As a result of this, the resin material 45 can be plasticized and kneaded more stably.

Since the tip of the screw 32 directs in the upward direction Z1, an angle θ1 between an axis L3 passing through the center of a resin slot 91 of the barrel 33 through which the resin material 45 is charged to the screw 32 and the axis L1 passing through the center of the screw 32 is preferably an acute angle.

Here, the axis L3 is also an axis passing through the center of a pipe 311 connected to the resin slot 91 of the barrel 33 in the hopper 31 through the cooling block 35. The pipe 311 of the hopper 31 is preferably connected to the barrel 33 via the cooling block 35 at an angle of 30° or more and 60° or less with respect to the direction in which the axis L1 of the screw 32 extends. That is, the angle θ1 is preferably an angle of 30° or more and 60° or less. As a result of the hopper 31 being connected to the barrel 33 such that the angle θ1 is 30° or more and 60° or less, the resin material 45 can be smoothly supplied to the screw 32 from the hopper 31. In addition, the resin material 45 having entered the screw 32 can be effectively prevented from moving back to the hopper 31. In this manner, the resin material 45 can be stably plasticized.

To be noted, in the case where the angle θ1 is larger than 0° and smaller than 15°, the resin material 45 can be stably supplied to the barrel 33 because the force of pushing the resin material 45 to the screw 32 is large, but the length required for the resin slot 91 is also large. Therefore, it is difficult to form the resin slot 91 in the barrel 33. In addition, in the case where the angle θ1 is larger than 60° and equal to or smaller than 90°, there is a possibility that the force of pushing back the resin material 45 from the barrel 33 surpasses the force of pushing the resin material 45 to the screw 32, and the supply of the resin material 45 to the barrel 33 becomes unstable.

As described above, by setting the angle θ1 to 30° or more and 60° or less, a force of always pushing the resin material 45 present at the resin slot 91 to the screw 32 can be generated by the weight of the resin material 45 reserved in the hopper 31. As a result of this, the supply of the resin material 45 to the barrel 33 is stabilized.

### Second Embodiment

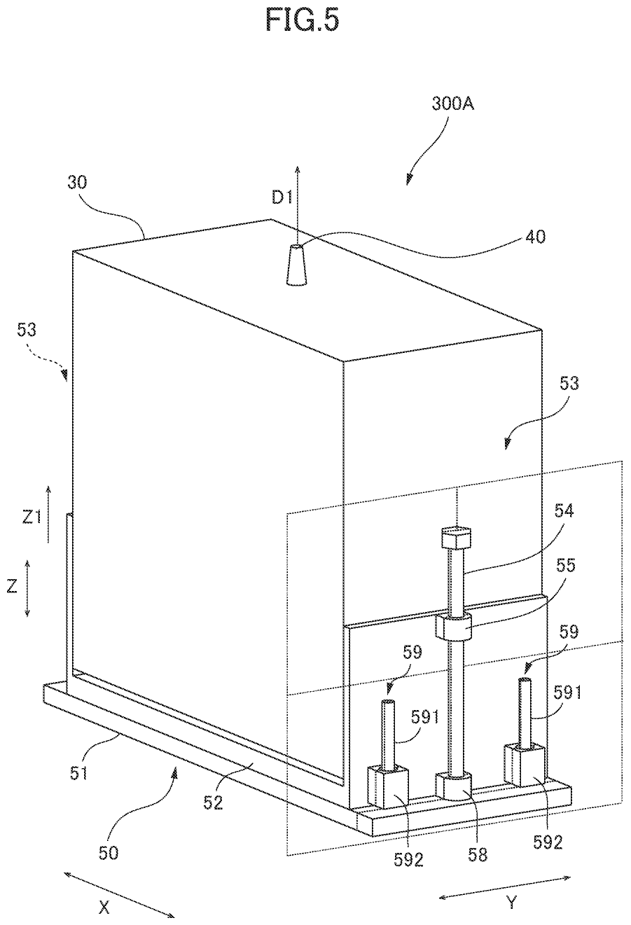

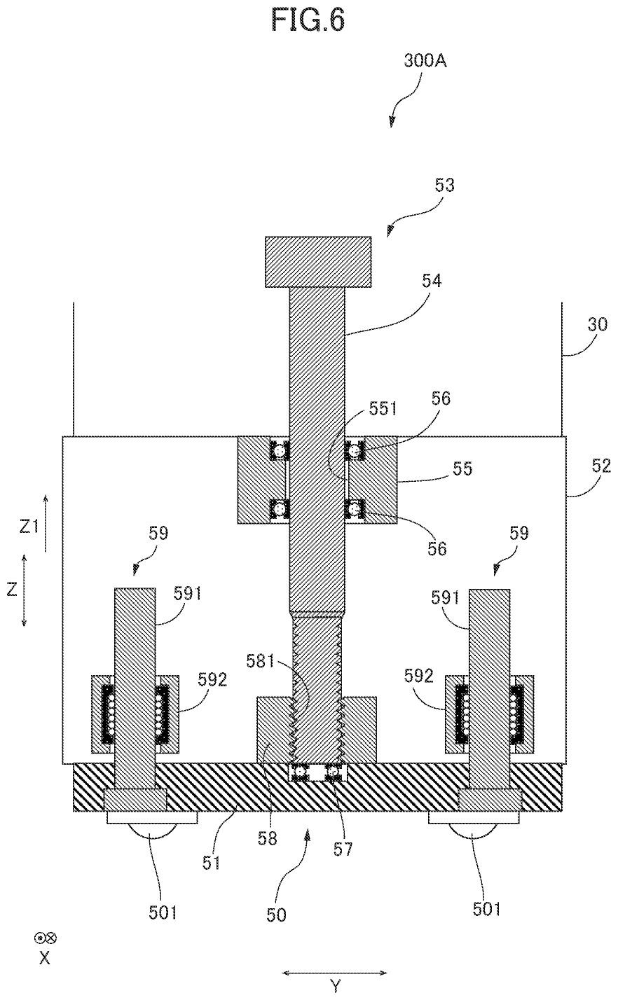

An injection apparatus of a second embodiment will be described. FIG. 5 is a perspective view of an injection apparatus 300A according to the second embodiment. FIG. 6 is a section view of the injection apparatus 300A along a dot line in FIG. 5. In the injection apparatus 300A in the second embodiment, elements similar to the injection apparatus 300 of the first embodiment will be denoted by the same reference signs and detailed description thereof will be omitted. In the second embodiment, the injection apparatus 300 of the manufacturing system 1000 of the first embodiment is replaced by the injection apparatus 300A.

The injection apparatus 300A includes the apparatus body 30 having a similar configuration to the first embodiment described above, and a lifting/lowering mechanism 50. The lifting/lowering mechanism 50 is an example of a second mechanism. The lifting/lowering mechanism 50 is capable of lifting and lowering the apparatus body 30 in the Z direction that is an up-down direction with respect to the mold 20 such that the apparatus body 30 comes into contact with and out of contact from the mold 20 illustrated in FIGS. 1 and 2. The lifting/lowering mechanism 50 is capable of lifting and lowering the apparatus body 30 in an orientation in which the ejection direction D1 of the first molding material from the nozzle 40 is the upward direction Z1.

The lifting/lowering mechanism 50 includes a base member 51 provided under the apparatus body 30, and a support member 52 that is provided on the base member 51 and supports the apparatus body 30. The support member 52 is formed in a U shape as viewed in the Y direction such that the apparatus body 30 fits therein. The apparatus body 30 is fixed to the support member 52 by an unillustrated fixing member.

The lifting/lowering mechanism 50 includes a pair of lifting/lowering portions 53 disposed on the respective sides of the support member 52 in the X direction that is a horizontal direction perpendicular to the Y direction. The lifting/lowering portions 53 have the same configuration. The X direction also serves as the longitudinal direction of the apparatus body 30.

The lifting/lowering portions 53 each include a bolt 54, a holding member 55 having a through hole 551 in which the shaft portion of the bolt 54 is inserted, and a radial bearing 56. In addition, the lifting/lowering portions 53 each include a thrust bearing 57, a member 58 in which a tap hole 581 that the bolt 54 is screwed into is defined, and a pair of guide portions 59.

A force required for lifting and lowering the apparatus body 30, that is, a rotational force is applied to the bolt 54. The member 58 having the tap hole 581 is provided at a side portion of the support member 52 in the X direction. The member 58 having the tap hole 581 moves in the axial direction, that is, in the Z direction as a result of the bolt 54 screwed into the tap hole 581 rotating. The holding member 55 is provided at a side portion of the support member 52 such that the through hole 551 of the holding member 55 and the tap hole 581 of the member 58 are coaxial. The radial bearing 56 is provided in the through hole 551 of the holding member 55 such that the bolt 54 and the tap hole 581 of the member 58 maintain high coaxiality. The thrust bearing 57 is disposed between the tip of the shaft portion of the bolt 54 and the base member 51 in order to relieve the frictional force generated between the tip of the shaft portion of the bolt 54 and the base member 51.

The pair of guide portions 59 are provided for guiding the support member 52, that is, the apparatus body 30 in the Z direction, and are arranged at an interval in the Y direction that is a horizontal direction perpendicular to the X direction. The Y direction also serves as a short direction of the apparatus body 30. The bolt 54 and the member 58 are disposed between the pair of guide portions 59. The guide portions 59 each include a linear guide 591 that is fixed to the base member 51 and includes a shaft portion extending in the Z direction, and a linear bush 592 which is provided at a side portion of the support member 52 in the X direction and in which the shaft portion of the linear guide 591 is inserted.

When attaching the injection apparatus 300A to the lower portion of the mold 20, the injection apparatus 300A needs to be conveyed to under the mold 20. In the second embodiment, a plurality of ball rollers 501 serving as an example of a movement mechanism for moving the apparatus body 30 are disposed at a lower portion of the base member 51. The apparatus body 30 can be conveyed to under the mold 20 by sliding the apparatus body 30 on the base 16 of FIG. 1 in the horizontal direction with respect to the injection molding machine 100 by the plurality of ball rollers 501. As a result of employing the ball rollers 501 as a movement mechanism, the apparatus body 30 can be easily moved in all the horizontal directions in the 360° as compared with a case of employing a caster that is used for general carriages and the like. As a result of this, the nozzle 40 of the apparatus body 30 can be easily adjusted to a position under the mold 20.

The apparatus body 30 conveyed to under the mold 20 needs to be lifted in the upward direction Z1 so as to bring the nozzle 40 into contact with the mold 20. In the second embodiment, the apparatus body 30 can be lifted in the upward direction Z1 by the lifting/lowering mechanism 50.

In the present embodiment, the apparatus body 30 can be lifted up by a worker rotating the bolts 54 of the pair of lifting/lowering portions 53 simultaneously or alternately by using a tool. Operation on one lifting/lowering portion 53 of the pair of lifting/lowering portions 53 will be described in detail below.

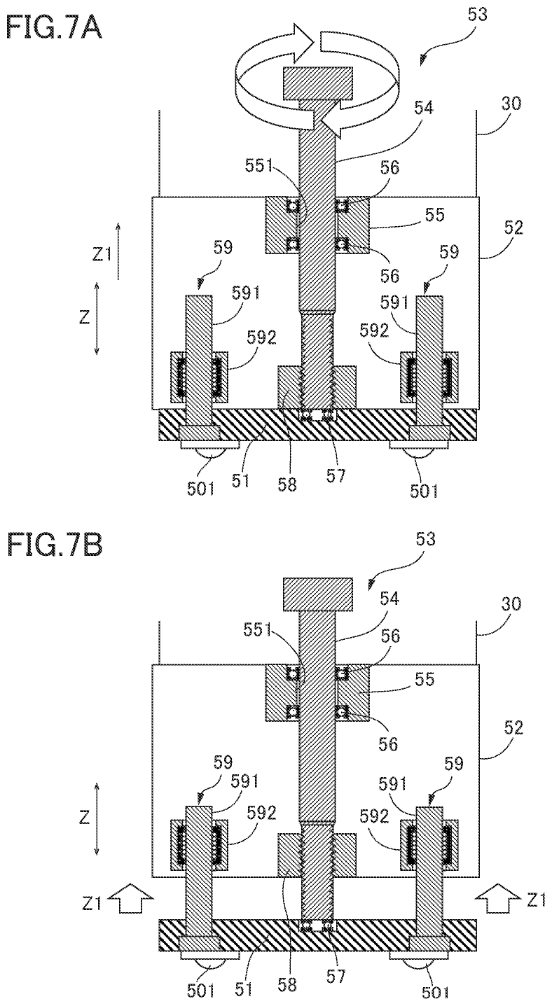

FIGS. 7A and 7B are explanatory diagrams of the operation of lifting up the apparatus body 30. By the worker rotating the bolts 54 at the side portion of the apparatus body 30 as illustrated in FIG. 7A, the holding member 55, the member 58, the support member 52, the linear bush 592, and the apparatus body 30 collectively ascend in accordance with the rotation amount of the bolt 54 as illustrated in FIG. 7B. The bolt 54 smoothly rotates with respect to the base member 51 as a result of the thrust bearing 57. In addition, the holding member 55 and the member 58 smoothly slide in the Z direction with respect to the rotating bolt 54 as a result of the radial bearing 56.

In addition, since the lifting/lowering mechanism 50 includes the lifting/lowering portions 53 disposed on the respective sides of the apparatus body 30 in the X direction, inclination of the apparatus body 30 in the lifting/lowering operation using the lifting/lowering mechanism 50 can be prevented. The bolts 54 of the respective lifting/lowering portions 53 may be alternately operated by one worker, but are preferably operated simultaneously by one or two workers.

According to the configuration described above, the worker does not need to prepare a conveyance apparatus such as a crane or a carriage for conveying the apparatus body 30 to under the mold 20. Therefore, the plannability is improved. In addition, the apparatus body 30 can be lifted up to the mold 20 by the lifting/lowering mechanism 50, and the load on the worker is reduced.

In addition, since the lifting/lowering mechanism 50 is a simple mechanism that lifts and lowers the apparatus body 30 by the bolts 54 without using a hydraulic cylinder or an air cylinder, the injection apparatus 300A can be miniaturized. As a result of this, the space occupied by the lifting/lowering mechanism 50 is small with respect to the limited space under the mold 20.

In addition, the speed at which the bolts 54 are rotated, that, the speed at which the apparatus body 30 is lifted up or lowered can be more easily controlled by the worker than in the case of using a hydraulic jack or an air cylinder. In addition, since the worker only needs to operate the bolts 54 to lift up and lower the apparatus body 30, it is also easy to stop the lifting/lowering work halfway at the circumstances of an unexpected event.

### Third Embodiment

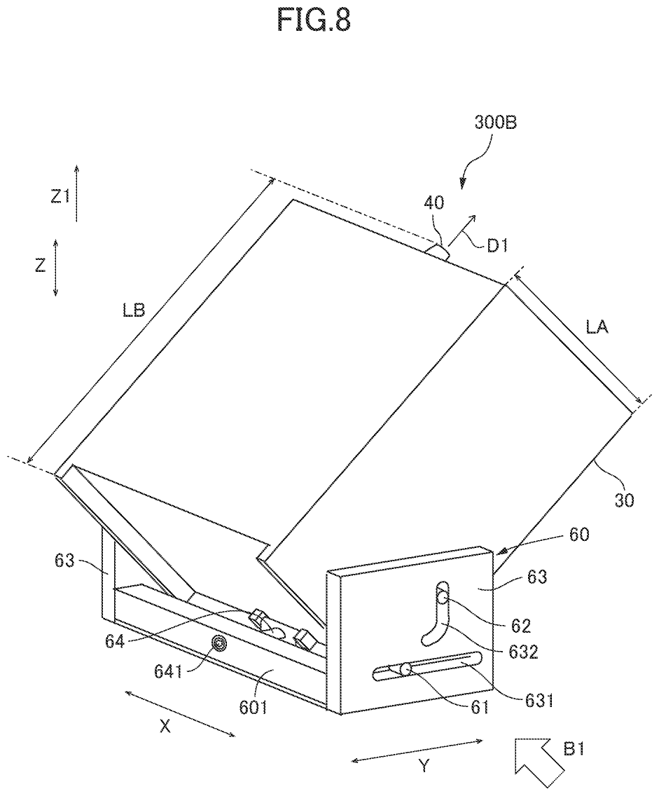

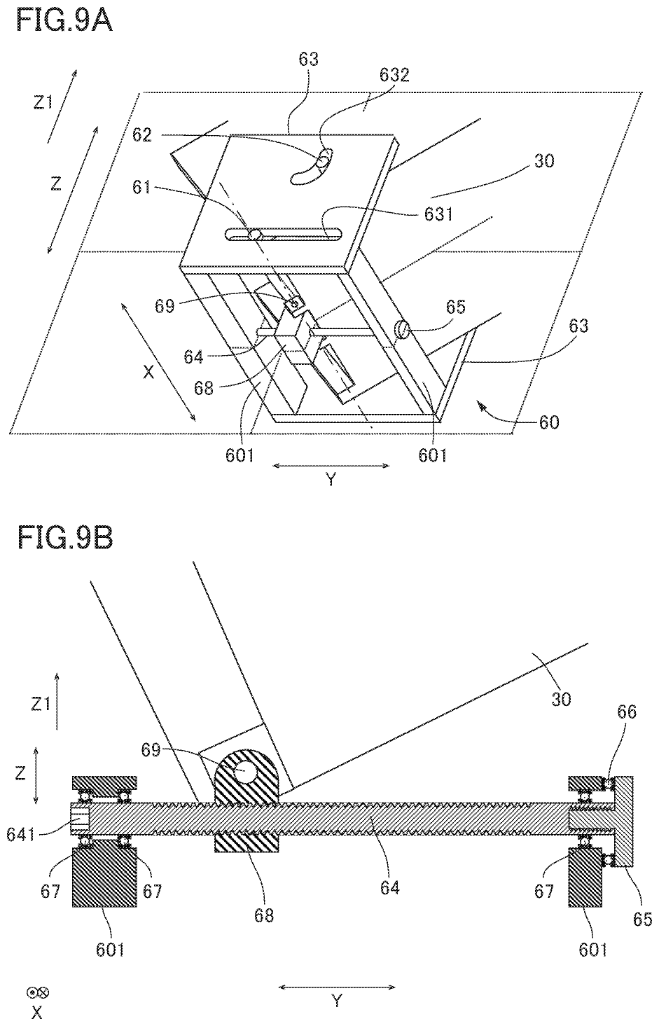

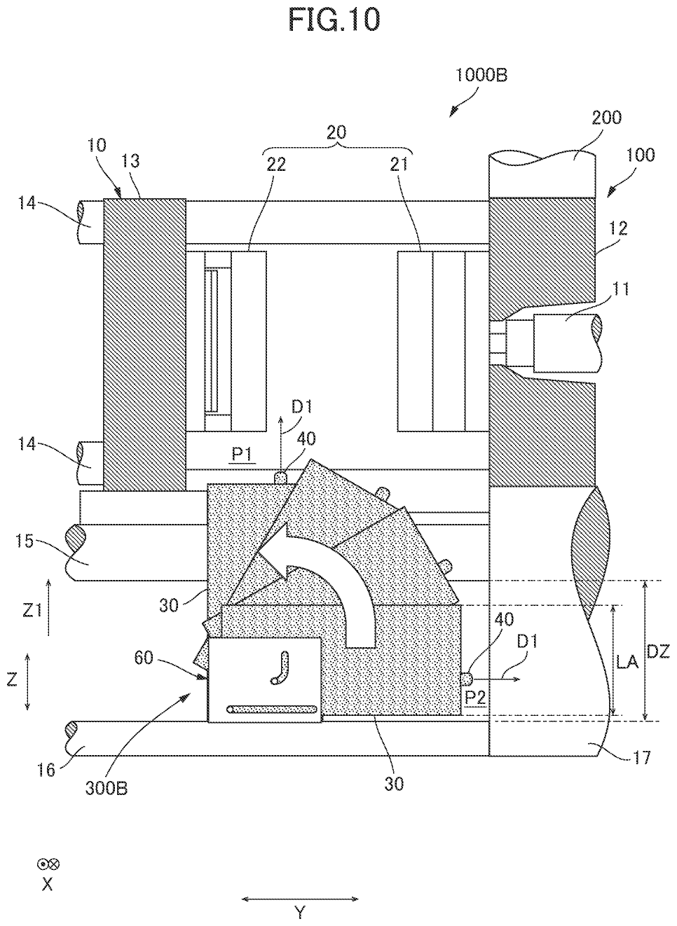

An injection apparatus of a third embodiment will be described. FIG. 8 is a perspective view of an injection apparatus 300B according to the third embodiment. FIG. 9A is a perspective view of the injection apparatus 300B as viewed in a direction of an arrow B1 of FIG. 8. FIG. 9B is a section view of the injection apparatus 300B along a dot line in FIG. 9A. FIG. 10 is an explanatory diagram of the operation of the injection apparatus 300B in a manufacturing system 1000B according to the third embodiment. In the third embodiment, elements similar to the first embodiment will be denoted by the same reference signs and detailed description thereof will be omitted. In the third embodiment, the injection apparatus 300 of the manufacturing system 1000 of the first embodiment is replaced by the injection apparatus 300B.

In the third embodiment, the manufacturing system 1000B includes the injection molding machine 100, the robot arm 200, and the mold 20 configured similarly to the first embodiment. FIG. 10 illustrates a state in which the mold 20 is open. In addition, the manufacturing system 1000B includes the injection apparatus 300B.

The injection apparatus 300B includes the apparatus body 30 of a similar configuration to the first embodiment described above, and a changing mechanism 60 capable of changing the orientation of the apparatus body 30. To be noted, although illustration is omitted, the injection apparatus 300B includes the first mechanism, for example, the attaching mechanism 41 of FIG. 1 and FIG. 2 in the first embodiment. In addition, although illustration is omitted, the injection apparatus 300B preferably includes the second mechanism, for example, the lifting/lowering mechanism 50 of FIG. 5 in the second embodiment.

The changing mechanism 60 is an example of a third mechanism. The changing mechanism 60 is capable of changing the orientation of the apparatus body 30 with respect to the mold 20. In the present embodiment, the changing mechanism 60 supports the apparatus body 30 such that the orientation of the apparatus body 30 can be changed between a first orientation P1 and a second orientation P2. The first orientation P1 is an orientation in which the ejection direction D1 of the nozzle 40 is the upward direction Z1 in the Z direction that is a direction perpendicular to the base 16. The second orientation P2 is an orientation in which the ejection direction D1 of the nozzle 40 is the Y direction that is a horizontal direction with respect to the base 16.

The changing mechanism 60 is provided under the apparatus body 30. The changing mechanism 60 includes a pair of side plates 63 disposed at an interval in the X direction, a pair of beam members 601 extending in the X direction and interconnecting the pair of side plates 63. The apparatus body 30 is disposed between the pair of side plates 63, and is swingably supported by the pair of side plates 63.

In addition, the changing mechanism 60 includes a bolt 64 extending in the Y direction and rotatably supported by the pair of beam members 601, and a joint 68 having a tap hole into which the bolt 64 is screwed and which is capable of linearly moving in the Y direction in accordance with the rotation of the bolt 64.

The apparatus body 30 is supported by the pair of side plates 63, and is rotatably coupled to the joint 68 via a shaft-shaped link 69 so as to take an orientation corresponding to the position of the joint 68 in the Y direction.

On respective sides of the apparatus body 30 in the X direction, a pair of shafts 61 that are coaxially provided, and a pair of shafts 62 that are coaxially provided are provided. In addition, the pair of shafts 61 and the link 69 are coaxially provided. The shafts 61 are each fitted in a guide groove 631 defined in each of the side plates 63 and linearly extending in the Y direction. The shafts 62 are each fitted in a guide groove 632 defined in each of the side plates 63 and having a curved shape. The guide grooves 632 are defined above the guide grooves 631 and defined to be curved so as to be convex diagonally downward.

At one end portion among the pair of end portions of the bolt 64 in the Y direction, a bolt stop 65 for preventing the bolt 64 from moving in the Y direction that is a thrust direction is provided. In addition, at the other end portion among the pair of end portions of the bolt 64 in the Y direction, a hexagonal hole 641 serving as an operation portion for the worker to rotationally operate the bolt 64 is provided. For example, the worker can rotate the bolt 64 by fitting a hexagonal wrench in the hexagonal hole 641 and rotating the hexagonal wrench.

A thrust bearing 66 is provided between the bolt 64 and the bolt stop 65. As a result of the thrust bearing 66, the frictional force between the bolt 64 and the bolt stop 65 is relieved. A radial bearing 67 is provided between the bolt 64 and each of the beam members 601. As a result of the radial bearing 67, the frictional force between the bolt 64 and the beam members 601 is relieved, and further, the bolt 64 and the pair of shafts 61 can be maintained at a right angle.

The pair of shafts 61 serve as a swing fulcrum of the apparatus body 30. The apparatus body 30 is capable of changing the orientation thereof by swinging with the pair of shafts 61 as a fulcrum. Regarding the apparatus body 30, the positions of the shafts 62 with respect to the guide grooves 632 are determined in accordance with the positions of the shafts 61 with respect to the guide grooves 631, and thus the orientation of the apparatus body 30 is determined. The positions of the shafts 61 with respect to the guide grooves 631 are determined in accordance with the position of the joint 68 with respect to the bolt 64.

That is, as a result of the worker rotating the bolt 64, the position of the joint 68 in the Y direction is determined, the positions of the shafts 61 in the guide grooves 631 and the positions of the shafts 62 in the guide grooves 632 are determined in accordance with the position of the joint 68 in the Y direction, and thus the orientation of the apparatus body 30 is determined.

The injection apparatus 300B needs to be conveyed to under the mold 20 attached to the mold clamping portion 10 of the injection molding machine 100. The stationary-side platen 12, the movable-side platen 13, the tie bar 14, the frame 15, and the base 16 are disposed around the mold 20. Therefore, a space surrounded by the stationary-side platen 12, the movable-side platen 13, the tie bar 14, the frame 15, the base 16, and the mold 20 is present under the mold 20. When conveying the injection apparatus 300B to under the mold 20, it is necessary to prevent the injection apparatus 300B from interfering with the mold 20 or the objects around the mold 20.

Here, in the present embodiment, a length LB of the apparatus body 30 in the Z direction is larger than a length LA of the apparatus body 30 in the Y direction in the case where the ejection direction D1 of the nozzle 40 is the upward direction Z1.

In the manufacturing system 1000B, in the state in which the mold 20 is clamped, a position where the gap in the Z direction is the widest in the space under the mold 20 is between the upper surface of the base 16 and the lower surface of the mold 20. In the manufacturing system 1000B, in the state in which the mold 20 is clamped, a position where the gap in the Z direction is the narrowest in the space under the mold 20 is between the upper surface of the base 16 and the lower surface of the frame 15.

Therefore, if an interval DZ between the upper surface of the base 16 and the lower surface of the frame 15 in the Z direction is larger than the length LA and smaller than the length LB, it is preferable to convey the apparatus body 30 to under the mold 20 in the lying second orientation P2. Further, after conveying the apparatus body 30 to under the mold 20, it is preferable to recover the apparatus body 30 to the erecting first orientation P 1.

As described above, even in the case where the space under the mold 20 is small, the apparatus body 30 can be conveyed to under the mold 20 by changing the orientation thereof by the changing mechanism 60. Particularly, in the case where the length LB of the apparatus body 30 is larger than the length LA, the apparatus body 30 can be conveyed to under the mold 20 by switching to the second orientation P2.

Then, the apparatus body 30 may be attached to the mold 20 by changing the apparatus body 30 to the first orientation P1. Therefore, according to the third embodiment, a conveyance device such as a crane does not need to be used when conveying the apparatus body 30 to under the mold 20, and further, the apparatus body 30 can be conveyed to under the mold 20 in a state in which the mold 20 is still attached to the mold clamping portion 10. Therefore, the plannability is improved.

In addition, the worker only has to rotate the bolt 64 when changing the orientation of the apparatus body 30. As a result of the worker rotating the bolt 64, the joint 68 moves in the horizontal direction, and the apparatus body 30 is changed to an orientation corresponding to the position of the joint 68 while the shafts 61 are guided by the guide grooves 631 and the shafts 62 are guided by the guide grooves 632.

In addition, since the injection apparatus 300 can be configured to be thin in the Y direction serving as an opening/closing direction of the mold 20, a plurality of injection apparatuses 300B can be also installed under the mold 20.

In addition, since the shafts 61 are capable of moving in the horizontal direction along the guide grooves 631 with respect to the side plates 63, the orientation of the apparatus body 30 can be changed in a smaller space than in the case of pivoting at a position where the shafts 61 are fixed to the side plates 63.

In addition, since the changing mechanism 60 is a simple mechanism that changes the orientation of the apparatus body 30 by the bolt 64 without using a hydraulic jack or an air cylinder, the injection apparatus 300B can be miniaturized. As a result of this, the space occupied by the changing mechanism 60 can be small in the limited space under the mold 20.

In addition, the speed for rotating the bolt 64, that is, the speed for changing the orientation of the apparatus body 30 can be more easily controlled by the worker than in the case of using a hydraulic jack or an air cylinder. In addition, since the worker only has to operate the bolt 64 to change the orientation of the apparatus body 30, it is also easy to stop the orientation changing work halfway at the circumstances of an unexpected event.

### Fourth Embodiment

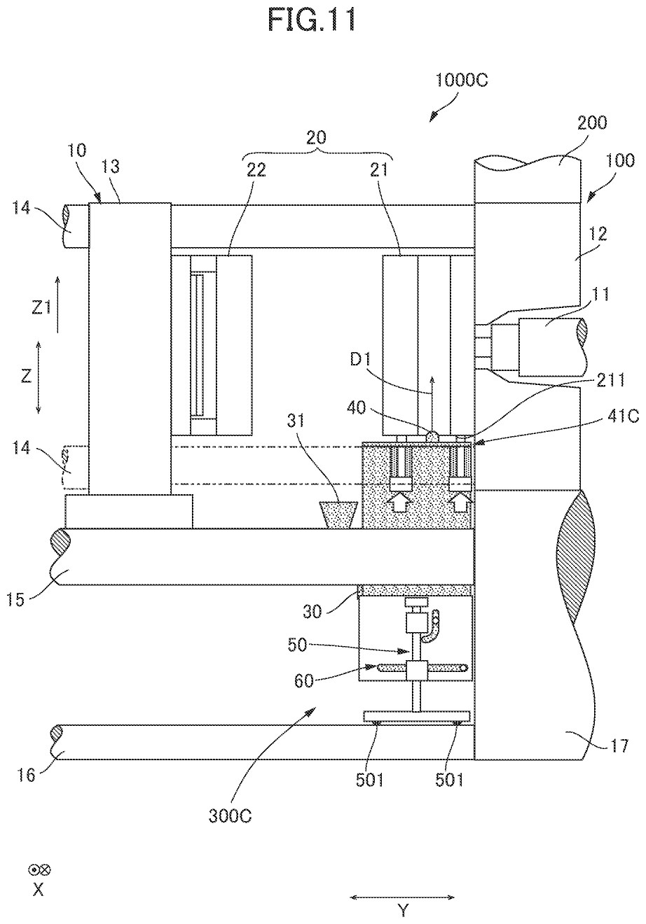

An injection apparatus of a fourth embodiment will be described. FIG. 11 is a side view of a manufacturing system 1000C according to the fourth embodiment. The manufacturing system 1000C includes an injection apparatus 300C having a different configuration from the first embodiment. To be noted, in the fourth embodiment, elements similar to the first embodiment will be denoted by the same reference signs and detailed description thereof will be omitted. In the fourth embodiment, the injection apparatus 300 of the manufacturing system 1000 of the first embodiment is replaced by the injection apparatus 300C.

The manufacturing system 1000C includes the injection molding machine 100, the robot aim 200, and the mold 20 configured similarly to the first embodiment. FIG. 11 illustrates a state in which the mold 20 is opened. In addition, the manufacturing system 1000C includes the injection apparatus 300C. To be noted, in FIG. 11, for the sake of convenience of description, one of a plurality of tie bars 14 of the mold clamping portion 10 of the injection molding machine 100 is indicated by a hidden line, that is, a two-dot chain line.

The injection apparatus 300C includes the apparatus body 30 configured similarly to the first embodiment described above, the lifting/lowering mechanism 50 configured similarly to the second embodiment described above, and the changing mechanism 60 configured similarly to the third embodiment described above.

The injection apparatus 300C includes an attaching mechanism 41C serving as an example of a first mechanism capable of attaching the apparatus body 30 to the mold 20.

The attaching mechanism 41C is capable of attaching the apparatus body 30 to the mold 20 in an orientation in which the ejection direction D1 of the first molding material from the nozzle 40 is the upward direction Z1. In the present embodiment, the attaching mechanism 41C is capable of attaching the apparatus body 30 to the stationary mold 21 among the stationary mold 21 and the movable mold 22 of the mold 20. In the orientation of the apparatus body 30 in which the ejection direction D1 is the upward direction Z1, the hopper 31 is open in the upward direction Z1.

The apparatus body 30 is attached to the lower surface 211 of the stationary mold 21 of the mold 20 by the attaching mechanism 41C in a state in which the apparatus body 30 is lifted up in the Z direction by the lifting/lowering mechanism 50 and the nozzle 40 is in contact with the lower surface 211 of the stationary mold 21 of the mold 20 so as to communicate with the hot runner R1 illustrated in FIG. 2.

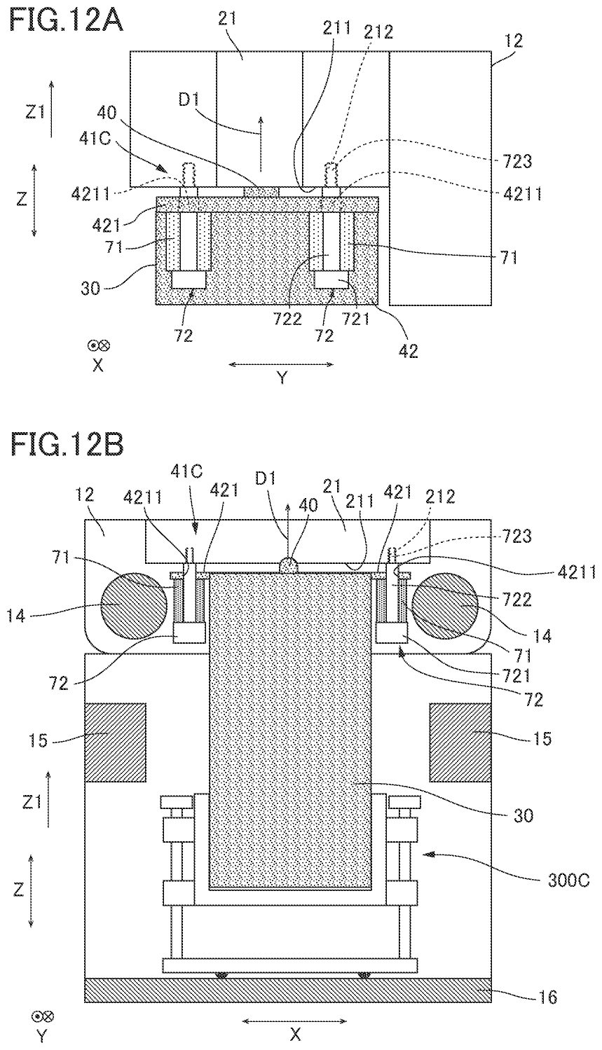

FIGS. 12A and 12B are plan views of the attaching mechanism 41C. FIGS. 12A and 12B also illustrate members around the attaching mechanism 41C. FIG. 12A illustrates the attaching mechanism 41C as viewed in the X direction, and FIG. 12B illustrates the attaching mechanism 41C as viewed in the Y direction. FIGS. 12A and 12B illustrate a state in which the apparatus body 30 is attached to the stationary mold 21 of the mold 20 by the attaching mechanism 41C.

The attaching mechanism 41C includes a plurality of, for example, four stepped bolts 72 as examples of a fastening member capable of coupling the apparatus body 30 to the stationary mold 21 of the mold 20. The stepped bolt 72 includes a head portion 721, a shaft portion 722 extending from the head portion 721 in the Z direction serving as an axial direction, and a screw portion 723 provided at the tip of the shaft portion 722 in the Z direction and having a smaller diameter than the shaft portion 722. A thread is formed on the outer circumferential surface of the screw portion 723. The lower surface 211 of the stationary mold 21 is provided with tap holes 212 into which the screw portions 723 are capable of being screwed.

The casing 42 of the apparatus body 30 includes a pair of flanges 421 respectively projecting in directions opposite to each other in the X direction. The flanges 421 are each fixed to the stationary mold 21 of the mold 20 by two stepped bolts 72. The flanges 421 each have two through holes 4211 extending in the Z direction. The diameter of each of the through holes 4211 is larger than the diameter of the shaft portion 722 of the stepped bolt 72, and is smaller than the diameter of the head portion 721 of the stepped bolt 72.

The shaft portions 722 and the screw portions 723 of the stepped bolts 72 respectively penetrate the through holes 4211, and the screw portions 723 are coupled to the tap holes 212 of the stationary mold 21. As a result of this, the apparatus body 30 can be attached to the stationary mold 21 of the mold 20.

The attaching mechanism 41C includes a plurality of, for example, four spring members 71 as examples of an urging member. The spring members 71 each generate an urging force urging the nozzle 40 in the ejection direction D1. The spring member 71 is, for example, a compression spring such as a disk spring or a coil spring.

The spring members 71 are fit on the shaft portions 722 of the stepped bolts 72, and are thus disposed between the head portions 721 of the stepped bolts 72 and the flanges 421. As a result of the screw portions 723 of the stepped bolts 72 being fastened to the stationary mold 21, the spring members 71 are nipped between the head portions 721 of the stepped bolts 72 and the flanges 421, and thus warp and deform. As a result of this, the spring members 71 each urge the nozzle 40 to the stationary mold 21.

As the stepped bolts 72 are fastened to the stationary mold 21, the shaft portions 722 come into contact with the lower surface 211 of the stationary mold 21 because there is a step between the shaft portions 722 and the screw portions 723 of the stepped bolts 72. As a result of this, the interval between the lower surface 211 of the stationary mold 21 and the head portions 721 of the stepped bolts 72 in the Z direction is maintained at a predetermined interval. The spring members 71 are pressed by the head portions 721 of the stepped bolts 72 in the Z direction, and warp and deform by a predetermined amount. As a result of this, a predetermined nozzle touch force that is appropriate can be generated in the nozzle 40. As described above, by using the stepped bolts 72, it is easy to perform the work of generating a predetermined appropriate nozzle touch force in the nozzle 40.

In addition, it is also possible to absorb the change in the interval between the mold 20 and the flanges 421 of the apparatus body 30 in the Z direction by the spring members 71 even in the case where the interval is changed due to change in temperature of the hot runner R1 of the mold 20, the nozzle 40 of the apparatus body 30, or the like.

In addition, since the attaching mechanism 41C is a simple mechanism that attaches the apparatus body 30 to the mold 20 by the stepped bolts 72 without using a hydraulic jack or an air cylinder, the injection apparatus 300C can be miniaturized. As a result of this, the space occupied by the attaching mechanism 41C can be small in the limited space under the mold 20.

### Fifth Embodiment

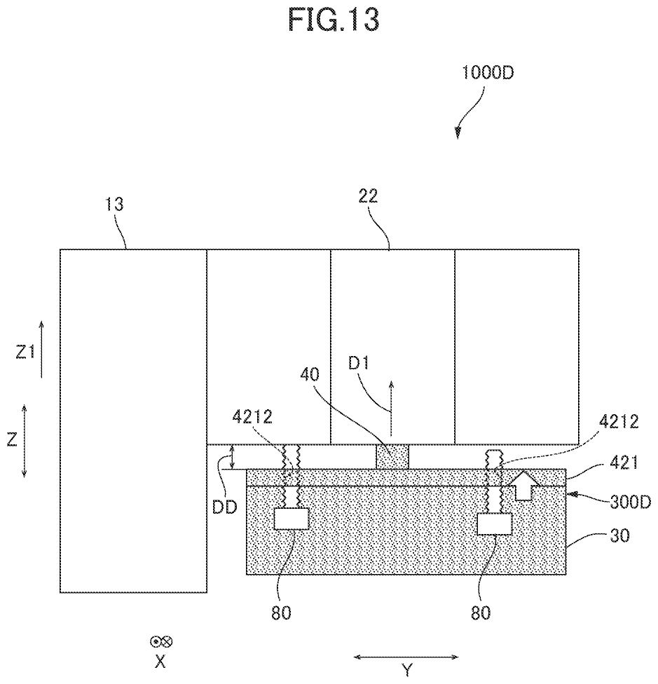

An injection apparatus of a fifth embodiment will be described. FIG. 13 is a side view of a manufacturing system 1000D according to the fifth embodiment. The manufacturing system 1000D includes an injection apparatus 300D having a different configuration from the first embodiment. To be noted, in the fifth embodiment, elements similar to the first embodiment will be denoted by the same reference signs and detailed description thereof will be omitted. In the fifth embodiment, the injection apparatus 300 of the manufacturing system 1000 of the first embodiment is replaced by the injection apparatus 300D.

The injection apparatus 300D of the manufacturing system 1000D includes the apparatus body 30 configured similarly to the first embodiment described above. To be noted, although the illustration is omitted in FIG. 13, the injection apparatus 300D includes the lifting/lowering mechanism 50 of FIG. 5 configured similarly to the second embodiment described above, the changing mechanism 60 of FIG. 8 configured similarly to the third embodiment described above, and the attaching mechanism 41C of FIG. 11 configured similarly to the fourth embodiment described above. To be noted, in the present embodiment, the attaching mechanism 41C is capable of attaching the apparatus body 30 to the movable mold 22.

In the case of attaching the apparatus body 30 to the movable mold 22 by the attaching mechanism 41C, an inertia force is applied to the apparatus body 30 in the Y direction serving as an opening/closing direction in accordance with the acceleration or deceleration by the opening/closing operation of the movable mold 22. Since the apparatus body 30 is fixed to the movable mold 22 via the spring members 71, in the case where the inertia force is applied in the Y direction, there is a possibility that a swing occurs with a contact portion between the hot runner R1 of FIG. 2 and the nozzle 40 as a fulcrum.

Therefore, in the present embodiment, the manufacturing system 1000D further includes a spacer 80 that maintains an interval DD between the movable mold 22 and the apparatus body 30. A plurality of, for example, two spacers 80 are provided for each of the pair of flanges 421. The two spacers 80 are arranged at an interval in the Y direction with the nozzle 40 interposed therebetween. As a result of this, the swing of the apparatus body 30 can be suppressed.

The spacers 80 are configured to be capable of adjusting the interval DD, and are constituted by bolts in the present embodiment. Tap holes 4212 into which shafts of the spacers 80 are screwed are defined in the flanges 421. The spacers 80 are provided on the flanges 421 by being screwed into the tap holes 4212 of the flanges 421. The projection amount of the spacers 80 in the Z direction with respect to the flanges 421 can be adjusted, and as a result of the tips of the shaft portions of the spacers 80 abutting the lower surface of the movable mold 22, the swing of the apparatus body 30 can be suppressed. To be noted, the projection amount of the spacers 80 in the Z direction with respect to the flanges 421 is preferably set to a length such that the nozzle touch force applied to the nozzle 40 is not distributed to the spacers 80.

As described above, in the present embodiment, the spacers 80 are bolts and have an adjusting function. As a result of this, the swing of the apparatus body 30 can be effectively suppressed even in the case where the distance between the mold 20 and the flanges 421 of the apparatus body 30 changes due to change in the temperature of the mold 20, the hot runner, or the nozzle 40.

### EXAMPLES

Experimental results of comparison between Examples 1 to 3 corresponding to the first embodiment and Comparative Examples 1 to 3 will be described. Examples 1 to 3 and Comparative Examples 1 to 3 were compared in variations in the amount measurement time and variations in the dimensions of the molded product when the angle θ1 of the resin slot 91 illustrated in FIG. 4 was changed.

As the screw 32, one having a length of 500 mm and a diameter of 25 mm was used. As the hopper 31, one formed from stainless steel was used. As the cooling block 35, one formed from aluminum was used. As the barrel 33, one formed from aluminum chromium molybdenum steel was used. The surface roughness of each of the hopper 31, the cooling block 35, and the barrel 33 was Ra 3.2. As the resin material 45, PMMA was used. The molded product had a rod shape having a diameter of 3 mm and a length of 320 mm.

In Examples 1 to 3 and Comparative Examples 1 to 3, molding was entirely performed in the molding conditions shown in Table 1.

TABLE 1

| | |
|---|---|
| RESIN TEMPERATURE | 260° C. |
| MOLD TEMPERATURE | 80° C. |
| CYCLE | 35 SEC |
| SCREW ROTATION | 80 rpm |
| SPEED | |
| BACK PRESSURE | 5 MPa |
| INJECTION SPEED | 100 mm/s |
| DWELL | 80 MPa |

For Examples 1 to 3 and Comparative Examples 1 to 3, the products were evaluated from the length required for the resin slot 91 and the variations in the dimensions of the molded product when setting the angle θ1 of the resin slot 91 to mutually different angles. The results of the evaluation are shown in Table 2. To be noted, “A” in the product evaluation shown in Table 2 indicates that the dimensional precision of the molded product serving as the product is sufficient. “B” in the product evaluation shown in Table 2 indicates that the dimensional precision of the molded product is inferior to “A”, or that the molded product was not successfully molded.

TABLE 2

| | | | COM- | EX- | EX- | EX- | COM- | COM- |
|---|---|---|---|---|---|---|---|---|
| | | | PARATIVE | AMPLE | AMPLE | AMPLE | PARATIVE | PARATIVE |
| | | | EXAMPLE 1 | 1 | 2 | 3 | EXAMPLE 2 | EXAMPLE 3 |
| CONDITIONS | RESIN SLOT ANGLE | [DEG] | 15 | 30 | 45 | 60 | 75 | 90 |
| | RESIN SLOT LENGTH | [mm] | 30 | | | | | |
| | (LONG HOLE Φ18) | | | | | | | |
| | BARREL THICKNESS | [mm] | 20 | | | | | |
| RESULTS | RESIN SLOT | [mm] | 105 | 65 | 50 | 42 | 35 | 30 |
| | REQUIRED LENGTH | | | | | | | |
| | AMOUNT MEASUREMENT | [SEC] | | 2.3 | 2.9 | 3.1 | 5.1 | 6.7 |
| | TIME VARIATION 3Σ (N10) | | | | | | | |
| | PRODUCT DIMENSION | [mm] | | 0.02 | 0.02 | 0.02 | 0.05 | 0.1 |
| | VARIATION 3Σ (N10) | | | | | | | |
| | PRODUCT EVALUATION | | B | A | A | A | B | B |

In Examples 1 to 3, the length required for the resin slot 91 was 42 mm to 65 mm, that is, about 1/10 of the length of the screw 32, which was a realistic length. In addition, the dimensional variations of the molded product was 3σ=0.02 mm, and molding with a sufficient precision was possible.

In contrast, in Comparative Example 1, the length required for the resin slot 91 was 105 mm, that is, ⅕ of the length of the screw 32, and the configuration was not realistic for the resin slot 91.

In Comparative Examples 2 and 3, the dimensional variation of the molded product was 3σ=0.05 mm or more, which was a range not problematic for the product specifications, but the dimensional variation of the molded product was large as compared with Examples 1 to 3. From the results shown above, it is preferable to manufacture the molded product in the range of Examples 1 to 3.

To be noted, the present invention is not limited to the embodiments described above, and can be modified in many ways within the technical concept of the present invention. In addition, the effects described in the embodiments are merely enumeration of the most preferable effects that can be obtained from the present invention, and the effects of the present invention are not limited to those described in the embodiments.

In the embodiments described above, the injection apparatus is attached to the lower surface of the mold and is therefore preferably of a screw pre-plunger type, and this case has been described, but this is not limiting, and for example, an in-line screw type may be employed. Similarly, although a case where the injection portion is of an in-line screw type has been described above, the screw pre-plunger type may be employed.

In addition, although a case where family molding is performed by the manufacturing system has been described in the embodiments described above, this is not limiting. The present invention is applicable to a manufacturing system in which two or more kinds of molded products or a molded product obtained by integrating two or more kinds of molded products is molded by injecting two or more kinds of molding materials having different compositions or colors into a single mold. As a result of this, integral molding such as family molding and multi-color molding can be performed easily or at a low cost by using molding materials of multiple material qualities or multiple colors by attaching the injection apparatus to the mold incorporated in a general-purpose lateral-type injection molding machine instead of using a dedicated molding machine for multiple material qualities or multiple colors.

In addition, in the embodiments described above, from the viewpoint of miniaturization of the apparatus body 30, a case where the axis L1 and the axis L2 are parallel or approximately parallel has been described. Although this configuration is preferable, the present invention is not limited to this. For example, the present invention is also applicable to a case where the axis L1 and the axis L2 cross at an angle larger than 10° or at a right angle.

In addition, in the embodiments described above, from the viewpoint of miniaturization of the manufacturing system in the state in which the apparatus body 30 to the mold 20, a case where the axes L1 and L2 are each parallel or approximately parallel to a normal line perpendicular to the upper surface of the base 16 has been described. Although this configuration is preferable, the present invention is not limited to this. For example, the present invention is also applicable to a case where the axes L1 and L2 each cross the normal line at an angle larger than 10° or at a right angle.

An improved manufacturing system can be provided. The other features and merits of the present invention will be revealed in the description below with reference to attached drawings. To be noted, in the attached drawings, the same or similar elements will be denoted by the same reference numerals.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An injection apparatus comprising:
a plasticizing portion configured to plasticize a molding material;
a nozzle configured to eject the molding material; and
a changing mechanism capable of changing an orientation of the plasticizing portion and the nozzle.

2. The injection apparatus according to claim 1, wherein the changing mechanism is capable of changing the orientation such that an ejection direction of the molding material from the nozzle is an upward direction.

3. The injection apparatus according to claim 2, further comprising an attaching mechanism capable of attaching the nozzle to a mold in the orientation in which the ejection direction is the upward direction.

4. The injection apparatus according to claim 3, wherein the changing mechanism is capable of changing the orientation of the nozzle such that the ejection direction is a horizontal direction.

5. The injection apparatus according to claim 3, further comprising a lifting/lowering mechanism capable of lifting and lowering the nozzle such that the nozzle comes into contact with and out of contact from the mold.

6. An injection apparatus configured to inject a first molding material into a first cavity defined in a mold, the injection apparatus comprising:
an apparatus body including a plasticizing portion configured to plasticize the first molding material, a nozzle configured to eject the first molding material, and a casing in which the plasticizing portion and the nozzle are disposed; and
a first mechanism capable of attaching the casing to the mold in an orientation in which an ejection direction of the first molding material from the nozzle is an upward direction.

7. The injection apparatus according to claim 6, further comprising a second mechanism capable of lifting and lowering the apparatus body such that the apparatus body comes into contact with and out of contact from the mold.

8. The injection apparatus according to claim 6, further comprising a third mechanism capable of changing the orientation of the apparatus body.

9. The injection apparatus according to claim 6, wherein the first mechanism includes a fastening member capable of coupling the apparatus body to the mold.

10. The injection apparatus according to claim 9, wherein the fastening member is a stepped bolt.

11. The injection apparatus according to claim 6, wherein the nozzle includes an urging member configured to generate an urging force for urging the nozzle in the ejection direction.

12. The injection apparatus according to claim 6, wherein the first mechanism is capable of attaching the apparatus body to a fixed mold among the fixed mold and a movable mold that are included in the mold.

13. The injection apparatus according to claim 6, wherein the first mechanism is capable of attaching the apparatus body to a movable mold among a fixed mold and the movable mold that are included in the mold.

14. An injection apparatus configured to inject a first molding material into a first cavity defined in a mold, the injection apparatus comprising:
an apparatus body including a nozzle configured to eject the first molding material; and
a first mechanism capable of attaching the apparatus body to the mold in an orientation in which an ejection direction of the first molding material from the nozzle is an upward direction,
wherein the first mechanism is capable of attaching the apparatus body to a movable mold among a fixed mold and the movable mold that are included in the mold, and
a spacer for maintaining an interval between the movable mold and the apparatus body is further provided.

15. The injection apparatus according to claim 14, wherein the spacer is capable of adjusting the interval.

16. The injection apparatus according to claim 6,
wherein the apparatus body includes
a cylinder coupled to the plasticizing portion and the nozzle,
a plunger disposed inside the cylinder, and
a driving portion configured to drive the plunger,
the cylinder, the plunger, and the driving portion are disposed inside the casing, and
the first molding material is ejected from the nozzle as a result of the driving portion causing the plunger to move forward.

17. The injection apparatus according to claim 6,
wherein the apparatus body includes
a screw,
a barrel disposed outside the screw, and
a hopper coupled to the barrel, and
in the orientation of the apparatus body in which the ejection direction is the upward direction, the hopper is open in the upward direction, and a tip of the screw directs in the upward direction.

18. The injection apparatus according to claim 17, wherein the hopper is coupled to the barrel at an angle of 30° or more and 60° or less with respect to a direction in which a rotation axis of the screw extends.

19. A manufacturing system comprising:
the injection apparatus according to claim 6; and
a mold clamping portion capable of opening and closing the mold in a horizontal direction.

20. The manufacturing system according to claim 19, further comprising an injection portion coupled to the mold from a different direction than the injection apparatus and configured to inject a second molding material into a second cavity defined by the mold.

21. The manufacturing system according to claim 19, wherein the mold includes a block defining a hot runner through which the nozzle of the injection apparatus and the first cavity communicate with each other.

22. The manufacturing system according to claim 21, wherein a lower surface of the block includes a portion that defines an inlet port of the hot runner and that the nozzle comes into contact with.

23. The manufacturing system according to claim 19, further comprising a take-out machine capable of taking out a product molded in the mold from above the mold that is opened.

24. The injection apparatus according to claim 1, further comprising:
a cylinder coupled to the plasticizing portion and the nozzle; and
a plunger for ejecting the molding material inside the cylinder from the nozzle,
wherein the changing mechanism is capable of changing an orientation of the cylinder and the plunger.

25. A manufacturing method for a product in which the product is manufactured by using the injection apparatus according to claim 1.

26. A manufacturing method for a product in which the product is manufactured by using the manufacturing system according to claim 19.
